(19) United States
(12) Patent Application Publication
(10) Pub. No.: US 2010/0231725 A1
(43) Pub. Date: Sep. 16, 2010

(54) ILLUMINANT INDEPENDENT COLOR CALIBRATION USING COLORED RAYS APPROACH

(75) Inventors: Xiaoling Wang, San Jose, CA (US); Farhan A. Baqai, Fremont, CA (US); Takami Mizukura, Kawasaki (JP); Naoya Katoh, Ichikawa (JP)

Correspondence Address: HAVERSTOCK & OWENS LLP, 162 N WOLFE ROAD, SUNNYVALE, CA, 94086, US

(73) Assignees: SONY CORPORATION, A JAPANESE CORPORATION, Tokyo (JP); SONY ELECTRONICS INC., Park Ridge, NJ (US)

(21) Appl. No.: 12/404,859

(22) Filed: Mar. 16, 2009

(51) Int. Cl. H04N 17/02

(52) U.S. Cl. 348/181; 348/E17.004

(57) ABSTRACT

The color calibration using colored rays method achieves illuminant independence in calibrating digital still cameras. A constraint is developed using matrix-vector operations and properties of the Kronecker product. The constraint ensures similar calibration performance between colored rays set and the Macbeth ColorChecker. An optimization scheme using orthogonal non-negative matrix factorization with the new constraint is able to obtain the optimal colored rays set. Then, by acquiring an image of the optimal colored rays set, a camera is able to determine an adjustment matrix for color calibration. Experimental results show that compared to traditional calibration approach for digital still cameras, the colored rays approach gives smaller color error under various evaluation illuminants with only one shot needed.

### FIELD OF THE INVENTION

The present invention relates to the field of calibration. More specifically, the present invention relates to enhancing the calibration of a device invariant to illuminants using colored rays.

### BACKGROUND OF THE INVENTION

A digital still camera (DSC) or video camera (camcorder) has a sensor that is covered by a color filter array (CFA) to create pixel locations. A DSC typically uses red, green and blue (RGB) filters to create their image. Most current camcorders typically use cyan, magenta, yellow and green (CMYG) filters for the same purpose.

A conventional sensor is a charge-coupled device (CCD) or complimentary metal oxide semiconductor (CMOS). An imaging system focuses a scene onto the sensor and electrical signals are generated that correspond to the scene colors that get passed through the colored filters. Electronic circuits amplify and condition these electrical signals for each pixel location and then digitize them. Algorithms in the camera then process these digital signals and perform a number of operations needed to convert the raw digital signals into a pleasing color image that can be shown on a color display or sent to a color printer.

Each color camera has a unique sensor, CFA, and analog electronics system. The sensor and CFA have part-to-part variations. Accordingly, the electronic system needs to be calibrated for each camera. The goal is to make a “real world” scene captured with different cameras look the same when rendered on a display device. In order to calibrate an individual camera, the properties of the individual camera's primary color channels (CMYG for a camcorder; RGB for a DSC) need to be measured so that the individual camera's response to known colors can be quantized.

In the past, to calibrate a DSC, several pictures were taken with the DSC of objects with different colors. The more colors acquired, the better the calibration would be. The data from these pictures would then be transferred to a computer for analysis, and then parameters are adjusted within the DSC based on the analysis so that the DSC produces the best and most realistic colors as viewed by a human observer. As described above, this was necessary because there are part to part differences in each camera such as there are slight variations in each sensor.

Since the captured “real world” scene may be viewed under different illuminating conditions, the adjusted parameters with each DSC need to be illuminant invariant, i.e., they should be able to generate the most realistic colors no matter what viewing condition is involved. In the past, this has been achieved by taking multiple shots of calibration objects under various illuminants and parameter adjustment is carried out for each shot image. The main drawback of these systems is that they are very slow. It takes time to take a number of pictures of different objects under various illuminating conditions. It also takes time to transfer the data to a computer for analysis and calibration because typically the connection is slow.

### SUMMARY OF THE INVENTION

The color calibration using colored rays method achieves illuminant independence for digital still cameras under multiple illuminating conditions. A constraint ensures similar calibration performance between colored rays set and the Macbeth ColorChecker. The constraint is derived using matrix-vector operations and properties of the Kronecker product. An iterative scheme using orthogonal non-negative matrix factorization with the new constraint is able to obtain the optimal colored rays set for illuminant independent calibration. Then, by acquiring an image of the optimal colored rays set, a camera is able to determine an adjustment matrix for color calibration. Experimental results show that compared to traditional calibration approach for digital still cameras, the colored rays approach gives smaller color error under various evaluation illuminants and eliminates the need of multiple images acquisition.

In one aspect, a method of generating an optimal colored rays set and calibrating devices using the optimal colored rays set comprises deriving a constraint for illuminant independent colored rays, on a first device, applying Orthogonal Non-negative Matrix Factorization (ONMF) with the constraint, on the first device, obtaining the optimal colored rays set using ONMF, on the first device, acquiring an image of the optimal colored rays set, on a second device, minimizing a color error between acquisition and rendition, on the second device and determining an adjustment matrix, on the second device. The first device is offline. Calibrating the devices is in real-time. Calibrating the devices is illuminant independent. The first device and the second device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

In another aspect, a method of calibrating a device comprises acquiring an image of an optimal colored rays set and determining an adjustment matrix for calibrating the device. The method further comprises minimizing a color error between digital still camera acquisition and human visual system rendition. Calibrating the device is in real-time. Calibrating the device is illuminant independent. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

In yet another aspect, a system for generating an optimal colored rays set and calibrating devices using the optimal colored rays set comprises a first device configured for obtaining an optimal colored rays set and a second device configured for determining an adjustment matrix for calibrating the second device based on an acquired image of the optimal colored rays set. The first device is configured for deriving a constraint for illuminant independent colored rays. The first device is configured for applying Orthogonal Non-negative Matrix Factorization (ONMF) with the constraint. The second device is configured for acquiring an image of the optimal colored rays set. The second device is configured for minimizing a color error between acquisition and rendition. The first device is offline. Calibrating the devices is in real-time. Calibrating the devices is illuminant independent. The first device and the second device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

In another aspect, a device comprises a memory for storing an application, the application configured for minimizing a color error between acquisition and rendition and determining an adjustment matrix and a processing component coupled to the memory, the processing component configured for processing the application. The application is configured for calibrating the device in real-time. The application is configured for calibrating the device independent of an illuminant. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

In another aspect, an application stored in a memory of a device, the application comprises an image acquisition component configured for acquiring the raw data for the optimal colored rays set and an adjustment matrix component configured for determining an adjustment matrix by minimizing color error between acquisition and rendition. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

### BRIEF DESCRIPTION OF THE DRAWINGS

FIG. 1 illustrates calibration flow using MOCS colored rays.

FIG. 2 illustrates calibration flow using a Macbeth Color Checker.

FIG. 3 illustrates spectral distribution of the obtained optimal colored rays set.

FIG. 4 illustrates evaluation flow between AM_{MOCS} and AM_{MC24}.

FIG. 5 illustrates a comparison of average color error under illuminant D65.

FIG. 6 illustrates a comparison of average color error under illuminant A.

FIG. 7 illustrates a comparison of average color error under illuminant F6.

FIG. 8A illustrates a block diagram of an exemplary computing device.

FIG. 8B illustrates a block diagram of an exemplary computing device.

FIG. 9A illustrates a flow chart of a method of generating an optimal colored rays set.

FIG. 9B illustrates a flow chart of a method of implementing color calibration.

### DETAILED DESCRIPTION OF THE PREFERRED EMBODIMENT

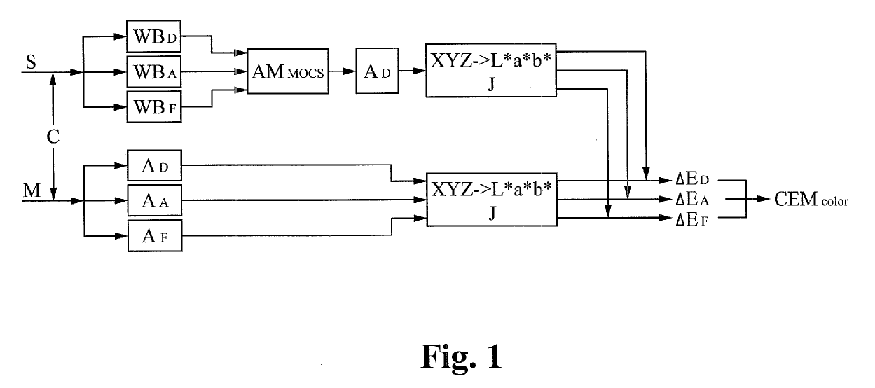

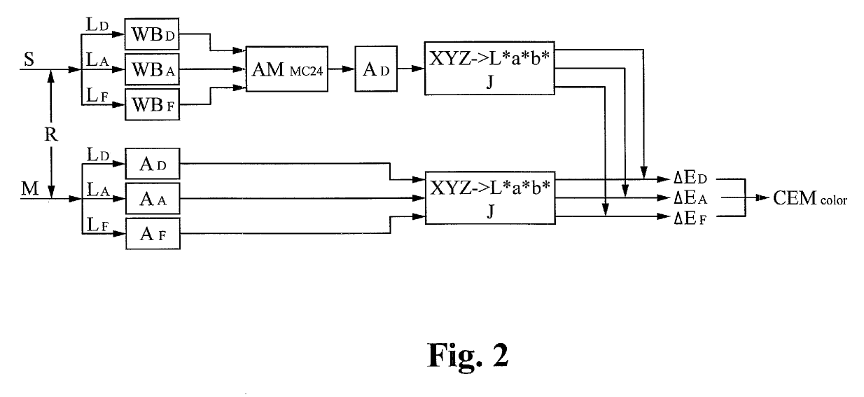

The objective of Digital Still Camera (DSC) color calibration is to find an optimal Adjustment Matrix (AM) which minimizes the perceived color error of a given target set of color patches as shown in FIGS. 1 and 2. At a designing stage, a master calibration camera is usually calibrated using a reflective Macbeth ColorChecker under multiple viewing illuminants. However, since the Macbeth ColorChecker includes 24 patches, it is not suitable for calibrating DSC products at the factory floor due to the computation and efficiency requirements. Therefore, at the manufacturing stage, a color chart referred to as TE106 is widely used for calibration under multiple viewing illuminants. The difference of calibration targets in design and manufacturing stages introduces an additional error, and a common chart is acquired to unite the two processes. Furthermore, current calibration for both the master calibration camera and DSC products are conducted under multiple illuminants, in other words, multiple shots are needed each time to calibrate a camera. This is usually achieved by extra mechanical equipment and requires additional real-time computation. To solve these problems, first, the non-negative property of Non-negative Matrix Factorization (NMF), as described in U.S. patent application Ser. No. 11/395,120, filed Mar. 31, 2006, entitled, “IDENTIFYING OPTIMAL COLORS FOR CALIBRATION AND COLOR FILTER ARRAY DESIGN” which is hereby incorporated by reference, is used to derive a physically realizable color set. Later, orthogonality constraint within the NMF is added to obtain an optimal reference color chart, as described in U.S. patent application Ser. No. 11/862,107, filed Sep. 26, 2007, entitled, “SYSTEM AND METHOD FOR DETERMINING AN OPTIMAL REFERENCE COLOR CHART” which is hereby incorporated by reference. Described herein is a new methodology for illuminant independent calibration based on optimizing colored rays.

In order to derive the constraint for generating optimal colored rays set in color calibration, it is useful to first introduce the vec(•) operator that transforms a matrix into a vector by stacking the columns of the matrix one underneath the other in sequence. For any matrices, A and B, their Kronecker product is defined as follows:

$${A}_{m \times n} ⊗ {B}_{p \times q} ≡ {[ \begin{matrix}{a}_{11} B & … & {a}_{1 n} B \\ ⋮ & ⋰ & ⋮ \\ {a}_{m 1} B & … & {a}_{mn} B\end{matrix} ]}_{mp \times nq} \qquad ( 1 )$$

It is also useful to list some properties of the vec(•) operator and the Kronecker product. For arbitrary matrices T, U, V and W, the following expressions hold:

(T+U) [symbol] (V+W)=T [symbol] V+T [symbol] W+U [symbol] V+U [symbol] W (2)

(T [symbol] U)(V [symbol] W)=TV [symbol] UW (3)

(T [symbol] U)^{T}=T^{T} [symbol] U^{T} (4)

vec(UVW)=(W^{T} [symbol] U) vec(V) (5)

In order to achieve illuminant independence, a set of color rays are considered as the input of the color calibration signal flow as shown in FIG. 1.

Then, the calibration problem is able to be formulated as

AM_{MOCS} [symbol] min(CEM_{color}) [symbol] (CEM_{color}²)

where the optimization metric CEM_{color}² is able to be formulated as:

$${CEM}_{color}^{2} = {w}_{D} {\sum }_{i = 1}^{γ} {( Δ {E}_{iD \_ MOCS} )}^{2} + {w}_{A} {\sum }_{i = 1}^{γ} {( Δ {E}_{iA \_ MOCS} )}^{2} + {w}_{F} {\sum }_{i = 1}^{γ} {( Δ {E}_{iF \_ MOCS} )}^{2} \qquad ( 6 )$$

where r is the number of color patches in the input colored rays set. Since

$$\begin{matrix}Δ {E}^{2} = Δ {L}^{2} + Δ {a}^{2} + Δ {b}^{2} , \\ then & ( 7 ) \\ \begin{matrix}{CEM}_{color}^{2} = {w}_{D} {\sum }_{i = 1}^{r} ( Δ {L}_{iD \_ MOCS}^{2} + Δ {a}_{iD \_ MOCS}^{2} + Δ {b}_{iD \_ MOCS}^{2} ) + \\ {w}_{A} {\sum }_{i = 1}^{r} ( Δ {L}_{iA \_ MOCS}^{2} + Δ {a}_{iA \_ MOCS}^{2} + Δ {b}_{iA \_ MOCS}^{2} ) + \\ {w}_{F} {\sum }_{i = 1}^{r} ( Δ {L}_{iF \_ MOCS}^{2} + Δ {a}_{iF \_ MOCS}^{2} + Δ {b}_{iF \_ MOCS}^{2} ) \\ = {w}_{D} Δ {L}_{iD \_ MOCS}^{2} + {w}_{D} Δ {a}_{iD \_ MOCS}^{2} + \\ {w}_{D} Δ {b}_{iD \_ MOCS}^{2} + … + {w}_{D} Δ {L}_{r D \_ MOCS}^{2} + \\ {w}_{D} Δ {a}_{r D \_ MOCS}^{2} + {w}_{D} Δ {b}_{r D \_ MOCS}^{2} + \\ {w}_{A} Δ {L}_{1 A \_ MOCS}^{2} + {w}_{A} Δ {a}_{1 A \_ MOCS}^{2} + \\ {w}_{A} Δ {b}_{1 A \_ MOCS}^{2} + … + {w}_{A} Δ {L}_{r A \_ MOCS}^{2} + \\ {w}_{A} Δ {a}_{r A \_ MOCS}^{2} + {w}_{A} Δ {b}_{r A \_ MOCS}^{2} + \\ {w}_{F} Δ {L}_{1 F \_ MOCS}^{2} + {w}_{F} Δ {a}_{1 F \_ MOCS}^{2} + \\ {w}_{F} Δ {b}_{1 F \_ MOCS}^{2} + … + {w}_{F} Δ {L}_{r F \_ MOCS}^{2} + \\ {w}_{F} Δ {a}_{r F \_ MOCS}^{2} + {w}_{F} Δ {b}_{r F \_ MOCS}^{2}\end{matrix} & \end{matrix}$$

The order of the summations is able to be rearranged and by using the definition of vector 2-norm, the following expression is obtained.

$$\begin{matrix}{CEM}_{color}^{2} = {w}_{D} Δ {L}_{1 D \_ MOCS}^{2} + {w}_{D} Δ {a}_{1 D \_ MOCS}^{2} + {w}_{D} Δ {b}_{1 D \_ MOCS}^{2} + \\ {w}_{A} Δ {L}_{1 A \_ MOCS}^{2} + {w}_{A} Δ {a}_{1 A \_ MOCS}^{2} + {w}_{A} Δ {b}_{1 A \_ MOCS}^{2} + \\ {w}_{F} Δ {L}_{1 F \_ MOCS}^{2} + {w}_{F} Δ {a}_{1 F \_ MOCS}^{2} + \\ {w}_{F} Δ {b}_{1 F \_ MOCS}^{2} + … + {w}_{D} Δ {L}_{r D \_ MOCS}^{2} + \\ {w}_{D} Δ {a}_{r D \_ MOCS}^{2} + {w}_{D} Δ {b}_{r D \_ MOCS}^{2} + {w}_{A} Δ {L}_{r A \_ MOCS}^{2} + \\ {w}_{A} Δ {a}_{r A \_ MOCS}^{2} + {w}_{A} Δ {b}_{r A \_ MOCS}^{2} + {w}_{F} Δ {L}_{r F \_ MOCS}^{2} + \\ {w}_{F} Δ {a}_{r F \_ MOCS}^{2} + {w}_{F} Δ {b}_{γ F \_ MOCS}^{2} \\ = {‖ [ \begin{matrix}\sqrt{{w}_{D}} Δ {L}_{1 D \_ MOCS} \\ \sqrt{{w}_{D}} Δ {a}_{1 D \_ MOCS} \\ \sqrt{{w}_{D}} Δ {b}_{1 D \_ MOCS} \\ \sqrt{{w}_{A}} Δ {L}_{1 A \_ MOCS} \\ \sqrt{{w}_{A}} Δ {a}_{1 A \_ MOCS} \\ \sqrt{{w}_{A}} Δ {b}_{1 A \_ MOCS} \\ \sqrt{{w}_{F}} Δ {L}_{1 F \_ MOCS} \\ \sqrt{{w}_{F}} Δ {a}_{1 F \_ MOCS} \\ \sqrt{{w}_{F}} Δ {b}_{1 F \_ MOCS} \\ ⋮ \\ \sqrt{{w}_{D}} Δ {L}_{r D \_ MOCS} \\ \sqrt{{w}_{D}} Δ {a}_{r D \_ MOCS} \\ \sqrt{{w}_{D}} Δ {b}_{r D \_ MOCS} \\ \sqrt{{w}_{A}} Δ {L}_{r A \_ MOCS} \\ \sqrt{{w}_{A}} Δ {a}_{r A \_ MOCS} \\ \sqrt{{w}_{A}} Δ {b}_{r A \_ MOCS} \\ \sqrt{{w}_{F}} Δ {L}_{r F \_ MOCS} \\ \sqrt{{w}_{F}} Δ {a}_{r F \_ MOCS} \\ \sqrt{{w}_{F}} Δ {b}_{r F \_ MOCS}\end{matrix} ] ‖}_{2}^{2}\end{matrix} \qquad ( 8 )$$

Let w′_{D}=\sqrt{w_{D}},w′_{A}=\sqrt{w_{A}},w_{F}=\sqrt{w_{F}}, and define J as the Jacobian matrix of the nonlinear transformation from CIEXYZ space to CIEL*a*b* space. Then, by using vec(•) operator, the color error metric is able to be formulated as

$$\begin{matrix}{CEM}_{cdor}^{2} = {‖ vec ( [ \begin{matrix}{w}_{D}^{′} Δ {L}_{1 D \_ MOCS} … {w}_{D}^{′} Δ {L}_{r D \_ MOCS} \\ {w}_{D}^{′} Δ {a}_{1 D \_ MOCS} … {w}_{D}^{′} Δ {a}_{r D \_ MOCS} \\ {w}_{D}^{′} Δ {b}_{1 D \_ MOCS} … {w}_{D}^{′} Δ {b}_{r D \_ MOCS} \\ {w}_{A}^{′} Δ {L}_{1 A \_ MOCS} … {w}_{A}^{′} Δ {L}_{r A \_ MOCS} \\ {w}_{A}^{′} Δ {a}_{1 A \_ MOCS} … {w}_{A}^{′} Δ {a}_{r A \_ MOCS} \\ {w}_{A}^{′} Δ {b}_{1 A \_ MOCS} … {w}_{A}^{′} Δ {b}_{r A \_ MOCS} \\ {w}_{F}^{′} Δ {L}_{1 F \_ MOCS} … {w}_{F}^{′} Δ {L}_{r F \_ MOCS} \\ {w}_{F}^{′} Δ {a}_{1 F \_ MOCS} … {w}_{F}^{′} {a }_{r F \_ MOCS} \\ {w}_{F}^{′} {Δ b}_{1 F \_ MOCS} … {w}_{F}^{′} {b }_{r F \_ MOCS}\end{matrix} ] ) ‖}_{2}^{2} & ( 9 ) \\ = {‖ vec ( \begin{matrix}[ {w}_{A}^{′} ( {[ \begin{matrix}{L}_{D \_ MOCS} \\ {a}_{D \_ MOCS} \\ {b}_{D \_ MOCS}\end{matrix} ]}_{3 \times r} - {[ \begin{matrix}{L}_{D \_ ref} \\ {a}_{D \_ ref} \\ {b}_{D \_ ref}\end{matrix} ]}_{3 \times r} ) ] \\ [ {w}_{A}^{′} ( {[ \begin{matrix}{L}_{A \_ MOCS} \\ {a}_{A \_ MOCS} \\ {b}_{A \_ MOCS}\end{matrix} ]}_{3 \times r} - {[ \begin{matrix}{L}_{A \_ ref} \\ {a}_{A \_ ref} \\ {b}_{A \_ ref}\end{matrix} ]}_{3 \times r} ) ] \\ [ {w}_{D}^{′} ( {[ \begin{matrix}{L}_{F \_ MOCS} \\ {a}_{F \_ MOCS} \\ {b}_{F \_ MOCS}\end{matrix} ]}_{3 \times r} - {[ \begin{matrix}{L}_{F \_ ref} \\ {a}_{F \_ ref} \\ {b}_{F \_ ref}\end{matrix} ]}_{3 \times r} ) ]\end{matrix} ) ‖}_{2}^{2} & \\ = {‖ vec ( [ \begin{matrix}\begin{matrix}{w}_{D}^{′} \cdot J \cdot {A}_{D} \cdot {AM}_{MOCS} \cdot {WB}_{D} \cdot {S}^{T} \cdot C - \\ {w}_{D}^{′} \cdot J \cdot {A}_{D} \cdot {M}^{T} \cdot C\end{matrix} \\ \begin{matrix}{w}_{A}^{′} \cdot J \cdot {A}_{A} \cdot {AM}_{MOCS} \cdot {WB}_{A} \cdot {S}^{T} \cdot C - \\ {w}_{A}^{′} \cdot J \cdot {A}_{A} \cdot {M}^{T} \cdot C\end{matrix} \\ \begin{matrix}{w}_{F}^{′} \cdot J \cdot {A}_{F} \cdot {AM}_{MOCS} \cdot {WB}_{F} \cdot {S}^{T} \cdot C - \\ {w}_{F}^{′} \cdot J \cdot {A}_{F} \cdot {M}^{T} \cdot C\end{matrix}\end{matrix} ] ) ‖}_{2}^{2} & \\ = ‖ vec ( [ \begin{matrix}{w}_{D}^{′} \cdot J \cdot {A}_{D} \cdot {AM}_{MOCS} \cdot {WB}_{D} \cdot {S}^{T} \cdot C \\ {w}_{A}^{′} \cdot J \cdot {A}_{A} \cdot {AM}_{MOCS} \cdot {WB}_{A} \cdot {S}^{T} \cdot C \\ {w}_{F}^{′} \cdot J \cdot {A}_{F} \cdot {AM}_{MOCS} \cdot {WB}_{F} \cdot {S}^{T} \cdot C\end{matrix} ] ) - & \\ { vec ( [ \begin{matrix}{w}_{D}^{′} \cdot J \cdot {A}_{D} \cdot {M}^{T} \cdot C \\ {w}_{A}^{′} \cdot J \cdot {A}_{A} \cdot {M}^{T} \cdot C \\ {w}_{F}^{′} \cdot J \cdot {A}_{F} \cdot {M}^{T} \cdot C\end{matrix} ] ) ‖}_{2}^{2} & \\ & \\ If Q = [ \begin{matrix}J \cdot {A}_{D} & 0 & 0 \\ 0 & J \cdot {A}_{D} & 0 \\ 0 & 0 & J \cdot {A}_{D}\end{matrix} ] \\ and P = [ \begin{matrix}{AM}_{MOCS} & 0 & 0 \\ 0 & {AM}_{MOCS} & 0 \\ 0 & 0 & {AM}_{MOCS}\end{matrix} ] , & \end{matrix}$$

then the color error metric is able to be stated as

$${CEM}_{cdor}^{2} = {‖ vec ( Q \cdot P \cdot [ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ] ) - vec ( [ \begin{matrix}{w}_{D}^{′} \cdot J \cdot {A}^{D} \cdot {M}^{T} \cdot C \\ {w}_{A}^{′} \cdot J \cdot {A}^{A} \cdot {M}^{T} \cdot C \\ {w}_{F}^{′} \cdot J \cdot {A}^{F} \cdot {M}^{T} \cdot C\end{matrix} ] ) ‖}_{2}^{2} \qquad ( 10 )$$

According to the property of Kronecker product in Equation (5), the above equation is able to be expressed as follows:

$${CEM}_{color}^{2} = {‖ ( {[ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ]}^{T} ⊗ Q ) \cdot vec ( P ) - vec ( [ \begin{matrix}{w}_{D}^{′} \cdot J \cdot {A}_{D} \cdot {M}^{T} \cdot C \\ {w}_{A}^{′} \cdot J \cdot {A}_{A} \cdot {M}^{T} \cdot C \\ {w}_{F}^{′} \cdot J \cdot {A}_{F} \cdot {M}^{T} \cdot C\end{matrix} ] ) ‖}_{2}^{2} \qquad ( 11 )$$

### Then

$${X}_{MOCS} = vec ( [ \begin{matrix}{w}_{D}^{′} \cdot J \cdot {A}_{D} \cdot {M}^{T} \cdot C \\ {w}_{A}^{′} \cdot J \cdot {A}_{A} \cdot {M}^{T} \cdot C \\ {w}_{F}^{′} \cdot J \cdot {A}_{F} \cdot {M}^{T} \cdot C\end{matrix} ] ) , \\ {Y}_{MOCS} = {[ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ]}^{T} ⊗ Q , \\ and {b}_{MOCS} = vec ( P ) ⇐ min ( {CEM}_{color}^{2} ) .$$

By this notation,
the color error metric is

CEM_{color}²=∥Y_{MOCS}·b_{MOCS}−X_{MOCS}∥₂² (12)

so b_{MOCS} is able to be solved using least square method as

b_{MOCS}=(Y_{MOCS}^{T}·Y_{MOCS})⁻¹(Y_{MOCS}^{T}·X_{MOCS}) (13)

By substituting the terms in Eq. (13), results in:

$${b}_{MOCS} = {[ {( {[ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ]}^{γ} ⊗ Q )}^{γ} ( {[ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ]}^{γ} ⊗ Q ) ]}^{- 1} \cdot [ {( {[ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ]}^{γ} ⊗ Q )}^{γ} \cdot vec ( [ \begin{matrix}{w}_{D}^{′} \cdot J \cdot {A}_{D} \cdot {M}^{T} \cdot C \\ {w}_{A}^{′} \cdot J \cdot {A}_{A} \cdot {M}^{T} \cdot C \\ {w}_{F}^{′} \cdot J \cdot {A}_{F} \cdot {M}^{T} \cdot C\end{matrix} ] ) ] \qquad ( 14 )$$

### Let

$${J}^{′} = [ \begin{matrix}J & 0 & 0 \\ 0 & J & 0 \\ 0 & 0 & J\end{matrix} ]$$

Let and apply Equation (4), then

$${b}_{MOCS} = {[ ( [ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ] ⊗ {Q}^{T} ) ( {[ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ]}^{T} ⊗ Q ) ]}^{- 1} \cdot [ ( [ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ] ⊗ {Q}^{T} ) \cdot vec ( J \cdot [ \begin{matrix}{w}_{D} \cdot {A}_{D} \cdot {M}^{T} \\ {w}_{A} \cdot {A}_{A} \cdot {M}^{T} \\ {w}_{F} \cdot {A}_{F} \cdot {M}^{T}\end{matrix} ] \cdot C ) ] \qquad ( 15 )$$

Then, by using Equations (3) and (5):

$${b}_{MOCS} = {[ ( [ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ] \cdot {[ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ]}^{T} ) ⊗ ( {Q}^{T} \cdot Q ) ]}^{- 1} \cdot [ ( [ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ] ⊗ {Q}^{T} ) \cdot ( {C}^{T} ⊗ J ) \cdot vec ( [ \begin{matrix}{w}_{D} \cdot J \cdot {A}_{D} \cdot {M}^{T} \\ {w}_{A} \cdot J \cdot {A}_{A} \cdot {M}^{T} \\ {w}_{F} \cdot J \cdot {A}_{F} \cdot {M}^{T}\end{matrix} ] ) ] \qquad ( 16 )$$

Then, applying Equation (3) again,

$$\begin{matrix}{b}_{MOCS} [ ( [ \begin{matrix}{w}_{D} \cdot {WB}_{D} \cdot {S}^{T} \cdot C \\ {w}_{A} \cdot {WB}_{A} \cdot {S}^{T} \cdot C \\ {w}_{F} \cdot {WB}_{F} \cdot {S}^{T} \cdot C\end{matrix} ] \cdot {[ \begin{matrix}{w}_{D} \cdot {WB}_{D} \cdot {S}^{T} \cdot C \\ {w}_{A} \cdot {WB}_{A} \cdot {S}^{T} \cdot C \\ {w}_{F} \cdot {WB}_{F} \cdot {S}^{T} \cdot C\end{matrix} ]}^{T} ) ⊗ \\ { ( {Q}^{T} \cdot Q ) ]}^{- 1} \cdot [ ( [ \begin{matrix}{w}_{D} \cdot {WB}_{D} \cdot {S}^{T} \cdot C \\ {w}_{A} \cdot {WB}_{A} \cdot {S}^{T} \cdot C \\ {w}_{F} \cdot {WB}_{F} \cdot {S}^{T} \cdot C\end{matrix} ] \cdot {C}^{T} ) ⊗ ( {Q}^{T} \cdot {J}^{′} ) \cdot \\ vec ( {J}^{′} \cdot [ \begin{matrix}{w}_{D}^{′} \cdot {A}_{D} \cdot {M}^{T} \\ {w}_{A}^{′} \cdot {A}_{A} \cdot {M}^{T} \\ {w}_{T}^{′} \cdot {A}_{F} \cdot {M}^{T}\end{matrix} ] ) ]\end{matrix} \qquad ( 17 )$$

Assuming the spectral reflectance function is sampled in the visible range [400 nm-700 nm] with 5 nm interval, then there are 61 samples for each spectral reflectance and colored ray. So:

$$\begin{matrix}[ \begin{matrix}{w}_{D}^{′} \cdot {WB}_{D} \cdot {S}^{T} \cdot C \\ {w}_{A}^{′} \cdot {WB}_{A} \cdot {S}^{T} \cdot C \\ {w}_{F}^{′} \cdot {WB}_{F} \cdot {S}^{T} \cdot C\end{matrix} ] = [ \begin{matrix}{w}_{D}^{′} \cdot {WB}_{D} \cdot {S}^{T} & 0 & 0 \\ 0 & {w}_{A}^{′} {WB}_{A} \cdot {S}^{T} & 0 \\ 0 & 0 & {w}_{F}^{′} \cdot {WB}_{F} \cdot {S}^{T}\end{matrix} ] \cdot [ \begin{matrix}{I}_{61} \\ {I}_{61} \\ {I}_{61}\end{matrix} ] \cdot C & ( 18 ) \\ and & \\ vec ( [ \begin{matrix}{w}_{D}^{′} \cdot {WB}_{D} \cdot {S}^{T} \\ {w}_{A}^{′} \cdot {WB}_{A} \cdot {S}^{T} \\ {w}_{F}^{′} \cdot {WB}_{F} \cdot {S}^{T}\end{matrix} ] ) = vec ( [ \begin{matrix}{w}_{D}^{′} \cdot {A}_{D} & 0 & 0 \\ 0 & {w}_{A}^{′} \cdot {A}_{A} & 0 \\ 0 & 0 & {w}_{F}^{′} \cdot {A}_{F}\end{matrix} ] \cdot [ \begin{matrix}{M}^{T} & 0 & 0 \\ 0 & {M}^{T} & 0 \\ 0 & 0 & {M}^{T}\end{matrix} ] \cdot [ \begin{matrix}{I}_{61} \\ {I}_{61} \\ {I}_{61}\end{matrix} ] ) & ( 19 )\end{matrix}$$

By applying Equation (5), the above expression is able to be changed to:

$$vec ( [ \begin{matrix}{w}_{D}^{′} \cdot {WB}_{D} \cdot {S}^{T} \\ {w}_{A}^{′} \cdot {WB}_{A} \cdot {S}^{T} \\ {w}_{F}^{′} \cdot {WB}_{F} \cdot {S}^{T}\end{matrix} ] ) = ( [ {I}_{61} {I}_{61} {I}_{61} ] ⊗ [ \begin{matrix}{w}_{D}^{′} \cdot {A}_{D} & 0 & 0 \\ 0 & {w}_{A}^{′} \cdot {A}_{A} & 0 \\ 0 & 0 & {w}_{F}^{′} \cdot {A}_{F}\end{matrix} ] \cdot vec [ \begin{matrix}{M}^{T} & 0 & 0 \\ 0 & {M}^{T} & 0 \\ 0 & 0 & {M}^{T}\end{matrix} ] ) \qquad ( 20 )$$

so if the corresponding terms are substituted in Equation (17) by Equations (18) and (20), the resulting expression is:

$$\begin{matrix}{b}_{MOCS} \{ ( [ \begin{matrix}{w}_{D} \cdot {WB}_{D} \cdot {S}^{T} & 0 & 0 \\ 0 & {w}_{A}^{′} \cdot {WB}_{A} \cdot {S}^{T} & 0 \\ 0 & 0 & {w}_{y}^{′} \cdot {WB}_{F} \cdot {S}^{T}\end{matrix} ] \cdot [ \begin{matrix}{I}_{61} \\ {I}_{61} \\ {I}_{61}\end{matrix} ] \cdot C \cdot {C}^{T} \cdot [ {I}_{61} {I}_{61} {I}_{61} ] \cdot \\ { [ \begin{matrix}{w}_{D} \cdot S \cdot {WB}_{A}^{T} & 0 & 0 \\ 0 & {w}_{A}^{′} \cdot S \cdot {WB}_{A}^{T} & 0 \\ 0 & 0 & {w}_{y}^{′} \cdot S \cdot {WB}_{y}^{T}\end{matrix} ] ) ⊗ ( {Q}^{T} \cdot Q ) \}}^{- 1} \cdot \\ \{ ( [ \begin{matrix}{w}_{D} \cdot {WB}_{D} \cdot {S}^{T} & 0 & 0 \\ 0 & {w}_{A} \cdot {WB}_{A} \cdot {S}^{T} & 0 \\ 0 & 0 & {w}_{y} \cdot {WB}_{F} \cdot {S}^{T}\end{matrix} ] \cdot [ \begin{matrix}{I}_{61} \\ {I}_{61} \\ {I}_{61}\end{matrix} ] \cdot C \cdot {C}^{T} ) ⊗ ( {Q}^{T} \cdot J ) \cdot \\ ( [ {I}_{61} {I}_{61} {I}_{61} ] ⊗ [ \begin{matrix}{w}_{D} \cdot {A}_{D} & 0 & 0 \\ 0 & {w}_{A}^{′} \cdot {A}_{A} & 0 \\ 0 & 0 & {w}_{F} \cdot {A}_{F}\end{matrix} ] ) \cdot vec ( [ \begin{matrix}{M}^{T} & 0 & 0 \\ 0 & {M}^{T} & 0 \\ 0 & 0 & {M}^{T}\end{matrix} ] ) \}\end{matrix} \qquad ( 21 )$$

After applying Equation (3) again on the above equation, the final result is:

$$\begin{matrix}{b}_{MOCS} \{ ( [ \begin{matrix}{W}_{D} \cdot {WB}_{D} \cdot {S}^{T} & 0 & 0 \\ 0 & {w}_{A}^{′} \cdot {WB}_{A} \cdot {S}^{T} & 0 \\ 0 & 0 & {w}_{y}^{′} \cdot {WB}_{y} \cdot {S}^{T}\end{matrix} ] \cdot [ \begin{matrix}{I}_{61} \\ {I}_{61} \\ {I}_{61}\end{matrix} ] \cdot C \cdot {C}^{T} \cdot [ {I}_{61} {I}_{61} {I}_{61} ] \cdot \\ { [ \begin{matrix}{w}_{D} \cdot S \cdot {WB}_{D}^{T} & 0 & 0 \\ 0 & {w}_{A}^{′} \cdot S \cdot {WB}_{A}^{T} & 0 \\ 0 & 0 & {w}_{y}^{′} \cdot S \cdot {WB}_{y}^{T}\end{matrix} ] ) ⊗ ( {Q}^{T} \cdot Q ) \}}^{- 1} \cdot \\ \{ ( [ \begin{matrix}{w}_{D} \cdot {WB}_{D} \cdot {S}^{T} & 0 & 0 \\ 0 & {w}_{A} \cdot {W}_{BA} \cdot {S}^{T} & 0 \\ 0 & 0 & {w}_{y} \cdot {WB}_{y} \cdot {S}^{T}\end{matrix} ] \cdot [ \begin{matrix}{I}_{61} \\ {I}_{61} \\ {I}_{61}\end{matrix} ] \cdot C \cdot {C}^{T} \cdot [ {I}_{61} {I}_{61} {I}_{61} ] ) ⊗ ( {Q}^{T} \cdot J ) \cdot \\ [ \begin{matrix}{w}_{D}^{′} \cdot {A}_{D} & 0 & 0 \\ 0 & {w}_{A} \cdot {A}_{A} & 0 \\ 0 & 0 & {w}_{F} \cdot {A}_{y}\end{matrix} ] ) \cdot vec ( [ \begin{matrix}{M}^{T} & 0 & 0 \\ 0 & {M}^{T} & 0 \\ 0 & 0 & {M}^{T}\end{matrix} ] ) \}\end{matrix} \qquad ( 22 )$$

The calibration flow using the Macbeth ColorChecker is illustrated in FIG. 2. It is different from the calibration flow using MOCS colored rays since three pictures are required for different illuminants, D65, A and F6. In other words, three shots are required to optimize the adjustment matrix (AM_{MC24}) which minimizes a comprehensive color error metric CEM_{color}.

The mathematical derivation of AM optimization using Macbeth ColorChecker follows the similar pattern as in, U.S. patent application Ser. No. 11/862,107, filed Sep. 26, 2007, entitled, “SYSTEM AND METHOD FOR DETERMINING AN OPTIMAL REFERENCE COLOR CHART,” and for simplicity, the details are omitted here. The final expression for AM_{MC24} is as follows:

$$\begin{matrix}{b}_{MC 24} = vec ( [ \begin{matrix}{AM}_{MC 24} & 0 & 0 \\ 0 & {AM}_{MC 24} & 0 \\ 0 & 0 & {AM}_{MC 24}\end{matrix} ] ) \\ = \{ ( [ \begin{matrix}{w}_{D} \cdot {WB}_{D} \cdot {S}^{T} & 0 & 0 \\ 0 & {w}_{A}^{′} \cdot {WB}_{A} \cdot {S}^{T} & 0 \\ 0 & 0 & {w}_{F}^{′} \cdot {WB}_{F} \cdot {S}^{T}\end{matrix} ] \cdot [ \begin{matrix}{L}_{D} \\ {L}_{A} \\ {L}_{F}\end{matrix} ] \cdot \\ R \cdot {R}^{T} \cdot [ {L}_{D} {L}_{A} {L}_{F} ] \cdot \\ { [ \begin{matrix}{w}_{D} \cdot S \cdot {WB}_{D}^{T} & 0 & 0 \\ 0 & {w}_{A}^{′} \cdot S \cdot {WB}_{A}^{T} & 0 \\ 0 & 0 & {w}_{F}^{′} \cdot S \cdot {WB}_{F}^{T}\end{matrix} ] ) ⊗ ( {Q}^{T} \cdot Q ) \}}^{- 1} \cdot \\ \{ ( [ \begin{matrix}{w}_{D} \cdot {WB}_{D} \cdot {S}^{T} & 0 & 0 \\ 0 & {w}_{A}^{′} \cdot {WB}_{A} \cdot {S}^{T} & 0 \\ 0 & 0 & {w}_{F}^{′} \cdot {WB}_{F} \cdot {S}^{T}\end{matrix} ] \cdot [ \begin{matrix}{L}_{D} \\ {L}_{A} \\ {L}_{F}\end{matrix} ] \cdot \\ R \cdot {R}^{T} \cdot [ {L}_{D} {L}_{A} {L}_{F} ] ) ⊗ ( {Q}^{T} \cdot J ) \cdot \\ [ \begin{matrix}{w}_{D} \cdot {A}_{D} & 0 & 0 \\ 0 & {w}_{A} \cdot {A}_{A} & 0 \\ 0 & 0 & {w}_{y} \cdot {A}_{y}\end{matrix} ] ) \cdot \\ vec ( [ \begin{matrix}{M}^{T} & 0 & 0 \\ 0 & {M}^{T} & 0 \\ 0 & 0 & {M}^{T}\end{matrix} ] ) \}\end{matrix} \qquad ( 23 )$$

In order to match the calibration performance between MOCS colored rays set C and Macbeth ColorChecker R, the complete condition is to match the corresponding adjustment matrix AM (e.g., b_{MOCS}≈z_{MC24}). Comparing the two expressions (22) and (23), it is noticeable that the two equations are very similar, and the only difference involves the illuminant matrices. Therefore

$${b}_{MOCS} \approx {b}_{MC 24} ⇔ [ \begin{matrix}{I}_{61} \\ {I}_{61} \\ {I}_{61}\end{matrix} ] \cdot C \cdot {C}^{T} \cdot [ {I}_{61} {I}_{61} {I}_{61} ] \approx [ \begin{matrix}{L}_{D} \\ {L}_{A} \\ {L}_{F}\end{matrix} ] \cdot R \cdot {R}^{T} \cdot [ {L}_{D} {L}_{A} {L}_{F} ] \qquad ( 24 )$$

The original Orthogonal Non-negative Matrix Factorization (ONMF) problem proposed in U.S. patent application Ser. No. 11/862,107, filed Sep. 26, 2007, entitled, “SYSTEM AND METHOD FOR DETERMINING AN OPTIMAL REFERENCE COLOR CHART” is to solve

V_{n×m}≈W_{n×r}·H_{r×m}

where W≧0, H≧0

H·H^{T}=I (25)

The orthogonality constraint of weight matrix H assures that V·V^{T}≈W·W^{T}.

The concept of colored rays which involves the effect of both spectral reflectance and illuminant has been mentioned. When associating the calibration formation (24) with the original ONMF problem (25), V is defined

$$V = [ \begin{matrix}{L}_{D} \\ {L}_{A} \\ {L}_{F}\end{matrix} ] \cdot R$$

$$and$$

$$W = [ \begin{matrix}{I}_{61} \\ {I}_{61} \\ {I}_{61}\end{matrix} ] \cdot C ,$$

then the relationship holds

$$V \cdot {V}^{T} \approx W \cdot {W}^{T} ⇔ [ \begin{matrix}{L}_{D} \\ {L}_{A} \\ {L}_{F}\end{matrix} ] \cdot R \cdot {R}^{T} \cdot [ {L}_{D} {L}_{A} {L}_{F} ] \approx [ \begin{matrix}{I}_{61} \\ {I}_{61} \\ {I}_{61}\end{matrix} ] \cdot C \cdot {C}^{T} \cdot [ {I}_{61} {I}_{61} {I}_{61} ]$$

This is exactly the requirement to match the calibration performance of MOCS colored rays and Macbeth. Therefore, ONMF is able to be easily applied to solve the problem of illuminant independent calibration.

After implementing ONMF on the illuminant weighted set

$$V = [ \begin{matrix}{L}_{D} \\ {L}_{A} \\ {L}_{F}\end{matrix} ] \cdot R ,$$

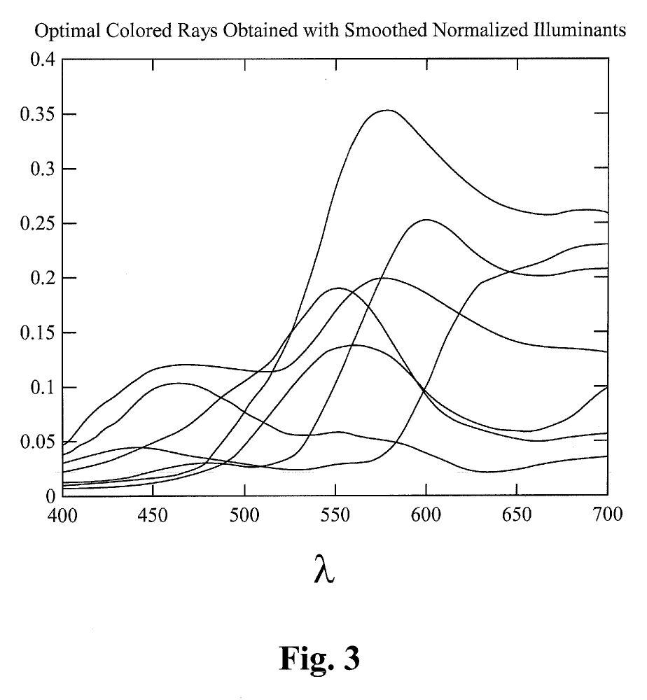

an optimal
colored rays set C is obtained. The spectral distribution of the colored rays set C is shown in FIG. 3, where smoothed versions of normalized illuminants (L_{D}, L_{A}, L_{F}) are employed.

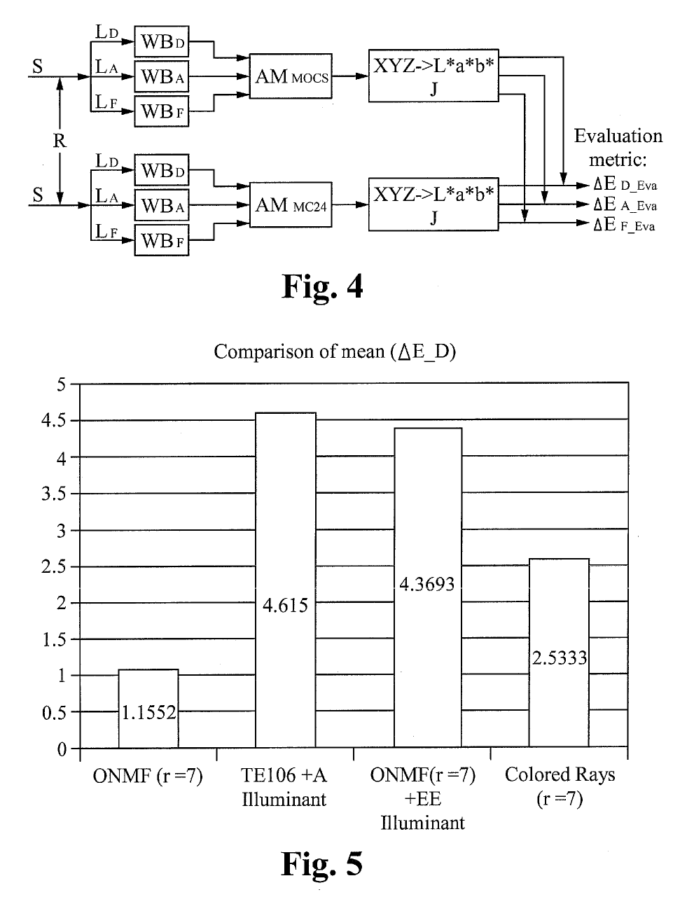

In order to evaluate the calibration performance of the generated optimal colored rays set C, it was applied to the calibration signal flow as shown in FIG. 1. As a comparison, AM_{MC24} is also optimized using the signal flow of FIG. 2. Then, the optimized AM_{MOCS} matrix is evaluated using the signal flow of FIG. 4 compared to the calibrated AM_{MC24} with Macbeth ColorChecker. The evaluation is conducted for three different illuminants: D65, A and F6. Small color errors under all three illuminants indicate good calibration performance.

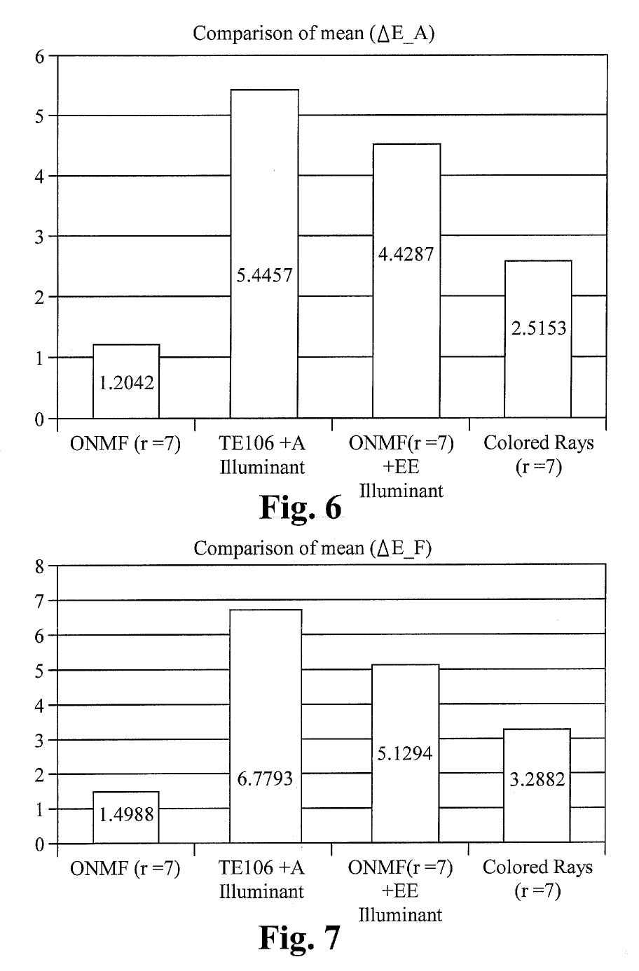

FIGS. 5-7 illustrate the comparison of average color error ΔE_{ab} under illuminants D65, A and F6 respectively. The comparison is among four different calibration targets: 1) the optimal reflectance set obtained by ONMF approach as in, U.S. patent application Ser. No. 11/862,107, filed Sep. 26, 2007, entitled, “SYSTEM AND METHOD FOR DETERMINING AN OPTIMAL REFERENCE COLOR CHART,” with three calibrating illuminants. In this case, three shots have to be taken which requires additional hardware equipment and consumes more time. 2) TE106 chart calibrated with illuminant A. TE106 color chart is a widely used for color calibration in TV products. It serves as a good comparison to the optimal colored rays in common calibration process. 3) Optimal ONMF reflectance set calibrated with equal energy illuminant. When considering the generation of optimal colored rays, the simplest solution is to use a single universal illuminant in equation (24), e.g., let L_{D}=L_{A}=L_{F}=L_{EE} where L_{EE} denotes the spectral distribution of equal energy illuminant. Therefore, this calibration target is included as the most intuitive colored rays solution for comparison. And 4) the optimal colored rays set C. As expected, the calibration with three illuminants exhibits the smallest color error but requires three shots of the scene during calibration. In all of the other three evaluation cases, only one shot is needed during calibration. Compared to the other approaches, the optimal color rays set provided better performance by having smaller color errors.

By using matrix-vector operation and properties of Kronecker product, a new framework to generate optimal colored rays for DSC calibration has been developed. The constraint ensures similar calibration performance between colored rays set and Macbeth ColorChecker. A new optimization scheme using the ONMF method described in U.S. patent application Ser. No. 11/862,107, filed Sep. 26, 2007, entitled, “SYSTEM AND METHOD FOR DETERMINING AN OPTIMAL REFERENCE COLOR CHART,” with the new constraint is developed to obtain the optimal colored rays set for illuminant independent calibration. Experimental results show that compared to traditional calibration approach for DSC, the colored rays approach gives smaller color error under various evaluation illuminants with less run-time requirement.

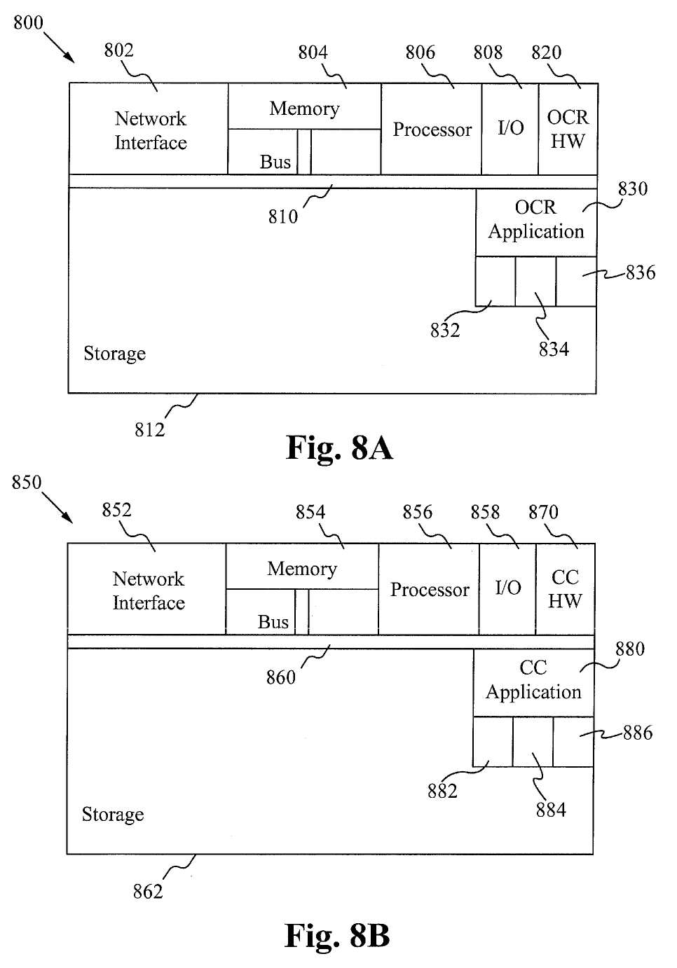

FIG. 8A illustrates a block diagram of an exemplary computing device 800 configured to obtain an optimal colored rays set. The computing device 800 is able to be used to acquire, store, compute, communicate and/or display information such as images and videos. For example, a computing device 800 derives a constraint for illuminant independent colored rays, applies ONMF with the constraint and obtains an optimal colored rays set. In general, a hardware structure suitable for implementing the computing device 800 includes a network interface 802, a memory 804, a processor 806, I/O device(s) 808, a bus 810 and a storage device 812. The choice of processor is not critical as long as a suitable processor with sufficient speed is chosen. The memory 804 is able to be any conventional computer memory known in the art. The storage device 812 is able to include a hard drive, CDROM, CDRW, DVD, DVDRW, flash memory card or any other storage device. The computing device 800 is able to include one or more network interfaces 802. An example of a network interface includes a network card connected to an Ethernet or other type of LAN. The I/O device(s) 808 are able to include one or more of the following: keyboard, mouse, monitor, display, printer, modem, touchscreen, button interface and other devices. Optimal colored rays application(s) 830 used to obtain an optimal colored rays set are likely to be stored in the storage device 812 and memory 804 and processed as applications are typically processed. More or less components shown in FIG. 8A are able to be included in the computing device 800. In some embodiments, optimal colored rays hardware 820 is included. Although the computing device 800 in FIG. 8A includes applications 830 and hardware 820 for obtaining optimal colored rays, the optimal colored rays method is able to be implemented on a computing device in hardware, firmware, software or any combination thereof.

In some embodiments, the optimal colored rays application 830 includes components/modules to accomplish each task. For example, in some embodiments, a constraint component 832 is utilized to derive a constraint for illuminant independent colored rays. An ONMF component 834 is utilized to apply ONMF with the constraint. A colored rays set component 836 is utilized to obtain an optimal colored rays set after implementing ONMF. In some embodiments, more or less components are included in the color calibration application 830.

FIG. 8B illustrates a block diagram of an exemplary computing device 850 to be color calibrated. The computing device 850 is able to be used to acquire, store, compute, communicate and/or display information such as images and videos. For example, a computing device 850 acquires an image of the optimal colored rays, minimizes color error and determines an adjustment matrix to calibrate the color on the computing device 850. In general, a hardware structure suitable for implementing the computing device 850 includes a network interface 852, a memory 854, a processor 856, I/O device(s) 858, a bus 860 and a storage device 862. The choice of processor is not critical as long as a suitable processor with sufficient speed is chosen. The memory 854 is able to be any conventional computer memory known in the art. The storage device 862 is able to include a hard drive, CDROM, CDRW, DVD, DVDRW, flash memory card or any other storage device. The computing device 850 is able to include one or more network interfaces 852. An example of a network interface includes a network card connected to an Ethernet or other type of LAN. The I/O device(s) 858 are able to include one or more of the following: keyboard, mouse, monitor, display, printer, modem, touchscreen, button interface and other devices. Color calibration application(s) 880 used to calibrate the color on the computing device are likely to be stored in the storage device 862 and memory 854 and processed as applications are typically processed. More or less components shown in FIG. 8B are able to be included in the computing device 850. In some embodiments, color calibration hardware 870 is included. Although the computing device 850 in FIG. 8B includes applications 880 and hardware 870 for color calibration, the color calibration using colored rays method is able to be implemented on a computing device in hardware, firmware, software or any combination thereof.

In some embodiments, the color calibration application 880 includes components/modules to accomplish each task. For example, in some embodiments, an image acquisition component 882 is utilized to acquire an image of the optimal colored rays. A error minimization component 884 is utilized to minimize color error between digital still camera acquisition and human visual system rendition. An adjustment matrix component 886 is utilized to determine an adjustment matrix which is used to calibrate the computing device. In some embodiments, more or less components are included in the color calibration application 880.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television, a home entertainment system or any other suitable computing device.

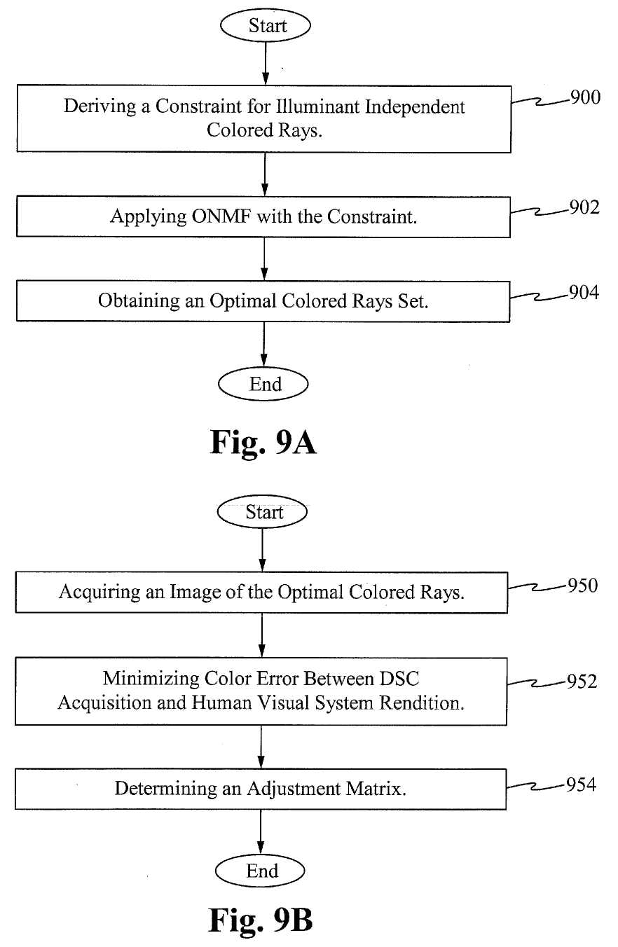

FIG. 9A illustrates a flow chart of a method of generating an optimal colored rays set. In some embodiments, the optimal colored rays set is generated offline. In the step 902, a constraint is derived for illuminant independent colored rays. In the step 904, ONMF is applied with the constraint. In the step 906, an optimal colored rays set is obtained using ONMF.

FIG. 9B illustrates a flow chart of a method of color calibrating a computing device. In some embodiments, the color calibrating occurs in real-time. In the step 950, an image of the optimal colored rays is acquired. In the step 952, color error between a digital still camera acquisition and the human visual system rendition is minimized. In the step 954, an adjustment matrix is determined. The adjustment matrix is then used to calibrate the computing device, such as a digital still camera.

To utilize the color calibration using colored rays method, a first computing device obtains an optimal colored rays set by deriving a constraint for illuminant independent colored rays and applying ONMF with the constraint. A second computing device acquires an image of the optimal colored rays. The second computing device then minimizes the color error between digital still camera acquisition and the human visual system rendition. The second computing device ultimately determines an adjustment matrix which is able to be applied, so that the second computing device is calibrated correctly. Once calibrated the computing device is able to acquire images in colors matching the colors seen in real life.

In operation, color calibration using colored rays improves the process of calibrating a computing device by making the process more efficient with the need of only capturing a single image for calibration. A first computing device obtains an optimal colored rays set. A second computing device, to be calibrated, then acquires an image of the optimal colored rays, minimizes a color error and then determines an adjustment matrix for calibrating the computing device. Once the computing device is calibrated, it operates as usual. The utilization of the computing device from the user's perspective is similar or the same as one that uses another form of calibration. For example, the user still simply turns on a digital camera and uses the camera to take pictures. With the camera calibrated properly, the images acquired are the appropriate color.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of generating an optimal colored rays set and calibrating devices using the optimal colored rays set comprising:
a. deriving a constraint for illuminant independent colored rays, on a first device;
b. applying Orthogonal Non-negative Matrix Factorization (ONMF) with the constraint, on the first device;
c. obtaining the optimal colored rays set using ONMF, on the first device;
d. acquiring an image of the optimal colored rays set, on a second device;
e. minimizing a color error between acquisition and rendition, on the second device; and
f. determining an adjustment matrix, on the second device.

2. The method of claim 1 wherein the first device is offline.

3. The method of claim 1 wherein calibrating the devices is in real-time.

4. The method of claim 1 wherein calibrating the devices is illuminant independent.

5. The method of claim 1 wherein the first device and the second device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

6. A method of calibrating a device comprising:
a. acquiring an image of an optimal colored rays set; and
b. determining an adjustment matrix for calibrating the device.

7. The method of claim 6 further comprising minimizing a color error between digital still camera acquisition and human visual system rendition.

8. The method of claim 6 wherein calibrating the device is in real-time.

9. The method of claim 6 wherein calibrating the device is illuminant independent.

10. The method of claim 6 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

11. A system for generating an optimal colored rays set and calibrating devices using the optimal colored rays set comprising:
a. a first device configured for obtaining an optimal colored rays set; and
b. a second device configured for determining an adjustment matrix for calibrating the second device based on an acquired image of the optimal colored rays set.

12. The system of claim 11 wherein the first device is configured for deriving a constraint for illuminant independent colored rays.

13. The system of claim 12 wherein the first device is configured for applying Orthogonal Non-negative Matrix Factorization (ONMF) with the constraint.

14. The system of claim 11 wherein the second device is configured for acquiring an image of the optimal colored rays set.

15. The system of claim 14 wherein the second device is configured for minimizing a color error between acquisition and rendition.

16. The system of claim 11 wherein the first device is offline.

17. The system of claim 11 wherein calibrating the devices is in real-time.

18. The system of claim 11 wherein calibrating the devices is illuminant independent.

19. The system of claim 11 wherein the first device and the second device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

20. A device comprising:
a. a memory for storing an application, the application configured for:
i. minimizing a color error between acquisition and rendition; and
ii. determining an adjustment matrix; and
b. a processing component coupled to the memory, the processing component configured for processing the application.

21. The device of claim 20 wherein the application is configured for calibrating the device in real-time.

22. The device of claim 20 wherein the application is configured for calibrating the device independent of an illuminant.

23. The device of claim 20 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

24. An application stored in a memory of a device, the application comprising:
a. an image acquisition component configured for acquiring the raw data for the optimal colored rays set; and
b. an adjustment matrix component configured for determining an adjustment matrix by minimizing color error between acquisition and rendition.

25. The application of claim 24 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.
